(19) United States
(12) Patent Application Publication
(10) Pub. No.: US 2005/0071141 A1
(43) Pub. Date: Mar. 31, 2005

(54) Modelling metabolic systems

(76) Inventor: Richard Butler, Aberdeen (GB)

Correspondence Address: TESTA, HURWITZ & THIBEAULT, LLP, HIGH STREET TOWER, 125 HIGH STREET, BOSTON, MA, 02110, US

(21) Appl. No.: 10/488,907

(22) PCT Filed: Sep. 6, 2002
(86) PCT No.: PCT/GB02/04060

(30) Foreign Application Priority Data
Sep. 6, 2001 (GB) 0121565.6

(51) Int. Cl. G06G 7/48

(52) U.S. Cl. 703/11

(57) ABSTRACT

A method of modelling a metabolic function of an individual is described, wherein a first (10A) and second (10B) set of data are input into a database (12). The first set of data (10A) may constitute information of the diet of an individual, whereas the second set of data (10B) may constitute information on the individual's activity. “Other” data (10C) may also be input into the database (12). A third set of data relating to hormone activity within the body is also included. A modelling region (20) employs a plurality of mathematical models in order to provide an output function (30, 31) indicative of the time variation of a metabolic function of the individual.

The present invention relates to the modelling of metabolic systems, and in particular the modelling of metabolic systems in order to provide information on the time variation of a metabolic function.

Over the years, a number of researchers have attempted to produce models of certain aspects of metabolic systems. For example, there are research teams working on mathematical models for diabetes in various countries at this time. However, their work tends to be based on the chemistry: of the processes involved, with a target audience of clinicians.

Often, these models are highly complicated, and are not able to provide information in a format which is easily digestible or understandable.

Similarly, when these models are based on detailed input data, they are often not suitable for use by untrained users, who may not be able to understand the equations, parameters, and variables involved. In addition, complicated input and analysis can be time-consuming, even for somebody expertly qualified.

Persons newly diagnosed with diabetes often need time and guidance to come to terms with the condition, and the limitations it can place on their lifestyle. Often, it will be necessary for a diabetic to undergo some exploratory research, in order to understand what their metabolic systems can cope with. Similarly, clinicians or dieticians may need to investigate the way an individual's metabolism operates so that an ideal insulin regimen can be formulated.

Athletes, and those who wish to lose weight, may require the same type of research in order to come up with information on the way diet and exercise effects their metabolism.

It would therefore be desirable to have a modelling system focused at people without clinical/dietary training as well as the healthcare professionals engaged in their day to day care.

Accordingly, it is one aim of the invention to provided a modelling system that simplifies the user interface.

It is a second aim of the invention to provide a modelling system that allows a user to enter reduced amounts of data.

It is a third aim of the invention to provide a modelling system that facilitates the individual (or a healthcare professional) to model the metabolism of the individual with a view to improving their control of their condition, improving their quality of life in the short and/or long term and/or improving their life expectancy.

Further aims and objects of the invention will become apparent from the following description.

According to a first aspect of the invention there is provided the method of modelling a metabolic function of an individual, comprising the steps of:
a) Inputting data into a database, including a first set of data relating to the diet of the individual and a second set of data relating to the activity of the individual, together with additional data which may include date of birth, sex, height, weight or any such data to be used later in the modelling method;
b) Providing a third set of data relating to activity of one or more hormones;
c) Employing a plurality of mathematical models that each utilise the third set of data in conjunction with at least one of the first set of input data and the second set of input data;
d) Providing an output function F1 indicative of the time variation of a metabolic function of the individual.

The third set of data may comprise a set of default parameters relating to the interaction of the one or more hormones with the individual.

In one embodiment, the method comprises the additional step of inputting or importing data relating to the measurement of a variable in a metabolic system. This measured data is preferably compared to modelled values calculated by the output function.

The comparison may involve the calculation of an error, said error being defined as the difference in the measured and modelled values expressed over time.

The method may contain the additional step of modifying at least one of the default parameters included in the third data set in order to reduce said error.

Preferably, this additional step is reiterated in order to minimise the error.

The hormone may be insulin.

The output function is preferably selected from the group comprising: insulin levels in the blood, input of glucose from diet, input of fat, liver glucose reserves, fat reserves, muscle reserves, glucose output due to activity, rate of change of urine glucose, glucose used by the central nervous system, modelled blood glucose, and blood glucose error.

Values calculated by the output function may be displayed to the user.

The method may provide two or more output functions.

The method may be executed by a computer program.

According to a second aspect of the invention, there is provided a computer program adapted to execute the method according to the first aspect.

According to a third aspect of the invention, there is provided a method for predicting the effect of a change in diet or activity on a metabolic function of an individual, comprising the steps of:
a) executing the steps of the method of the first aspect of the invention,
b) inputting data corresponding to a planned change in diet or activity into a database,
c) executing one or more of the mathematical models utilising the data corresponding to a planned change in diet or activity,
d) Providing an output function F2 indicative of the time variation of a metabolic function for the planned change in diet or activity.

Values calculated by the output function may be displayed to a user.

The method may comprise the additional step of comparing the output functions F1 and F2 in order to provide information on the difference effected by the change in diet or activity. Optionally, values calculated by the output function F2 may be displayed to the user only when a difference between output functions F1 and F2 is present.

The invention has particular, but not exclusive applications in:
The general care of people with Type 1 diabetes;
The general care of people with Type 2 diabetes;
The care of people with Type 1 or Type 2 diabetes with special personal circumstances, such as:
   (i) having a particularly active life,
   (ii) having dietary limitations (eg vegan, food allergies),
   (iii) who are over weight and wish to lose weight,
   (iv) who have reduced hypoglycaemic awareness,
   (v) who are ill.

The invention will help people with diabetes to control their condition and avoid diabetic comas in the short term and complications in the long term. It will also help non-diabetic people to balance their lifestyle and calorific intake, and thus help to control obesity. The invention also has applications in sports nutrition and other diet critical conditions, such as cholesterol control and heart disease.

Individual elements of the invention will help people who for instance, wish to model their diet, activity or medications and the effect these have on their own metabolism.

In contrast to known systems, the invention regards human metabolism as a system and is based on a novel systems engineering and modelling approach. This involves the modelling and analysis of energy input, storage and output under hormonal control. The following description is based primarily on modelling the role of the hormone insulin, but the same approach could be adapted for use with other hormones such as adrenaline and cortisol.

It is perhaps people with Type 1 diabetes that have the most pressing need for good control of blood glucose levels, as the alternative is to face long term complications. Good control is achieved by balancing various parameters such as insulin dose, food intake, activity, blood glucose levels, and the time relationships between these parameters. It is desirable for a person with Type 1 diabetes to model their own biological system and adapt their insulin regimen, diet and activity to achieve good control. The present invention models these parameters by viewing the person as a system and employing a mathematical model for each of these, and other parameters in order to determine how they affect the system. An important feature of the parameter models used in the present invention is that they show how the parameter and its effects vary with time.

Embodiments of the invention will now be described, by way of example only, with reference to the following figures, of which:

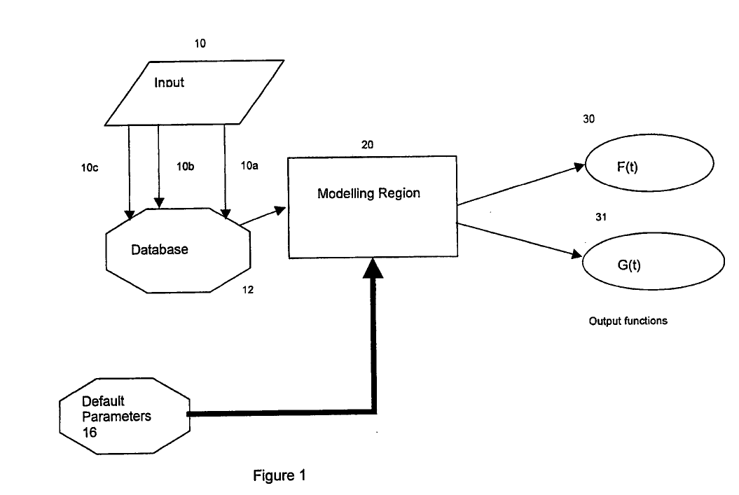

FIG. 1 shows a block diagram of a method of modelling a metabolic function according to a first aspect of the invention.

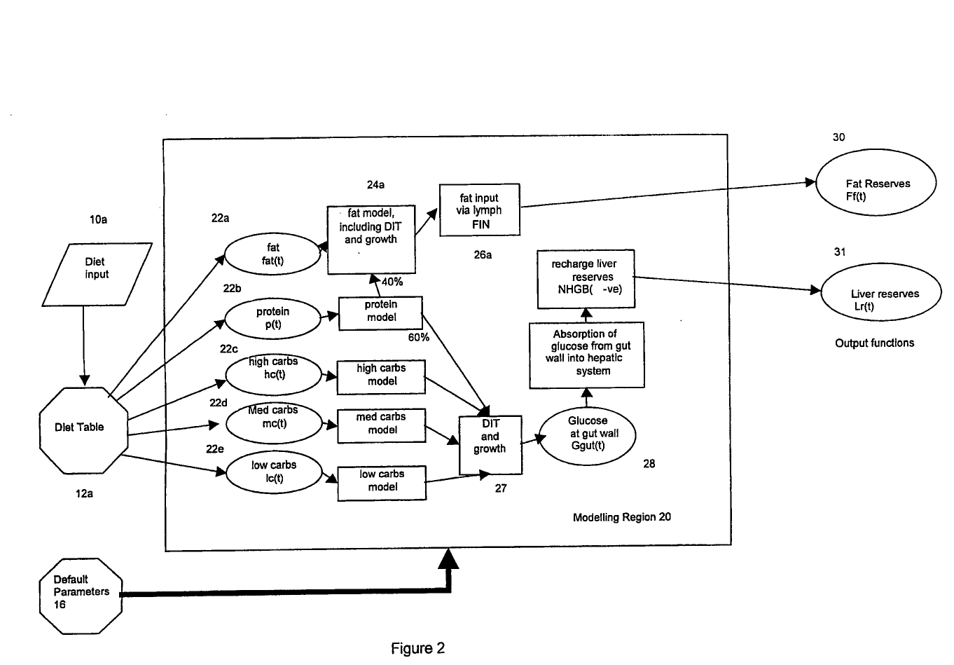

FIG. 2 shows a block diagram of a method according to one embodiment of the invention, with modelling region shown in detail.

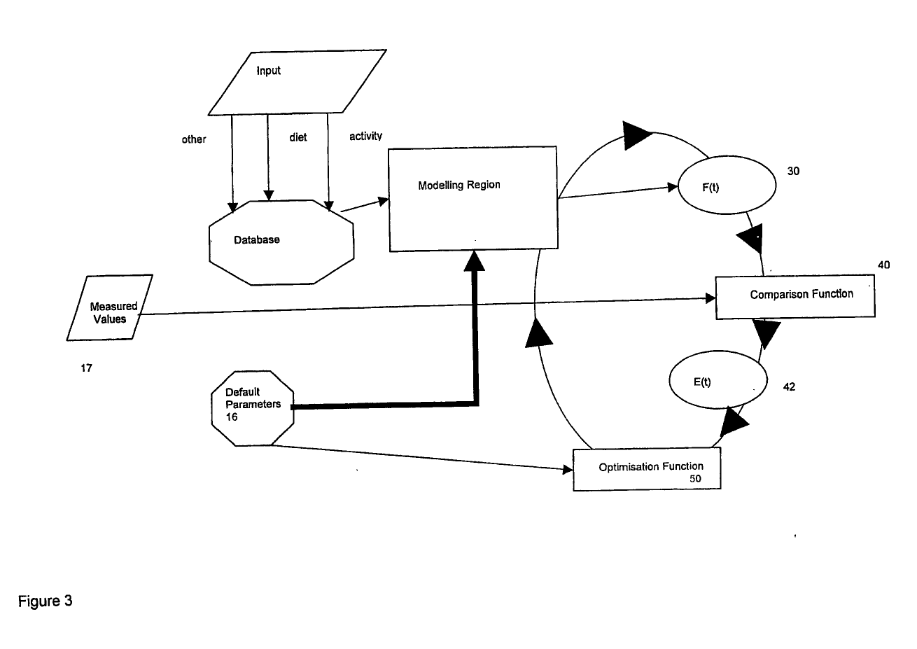

FIG. 3 shows a block diagram of a method including the input of measured values.

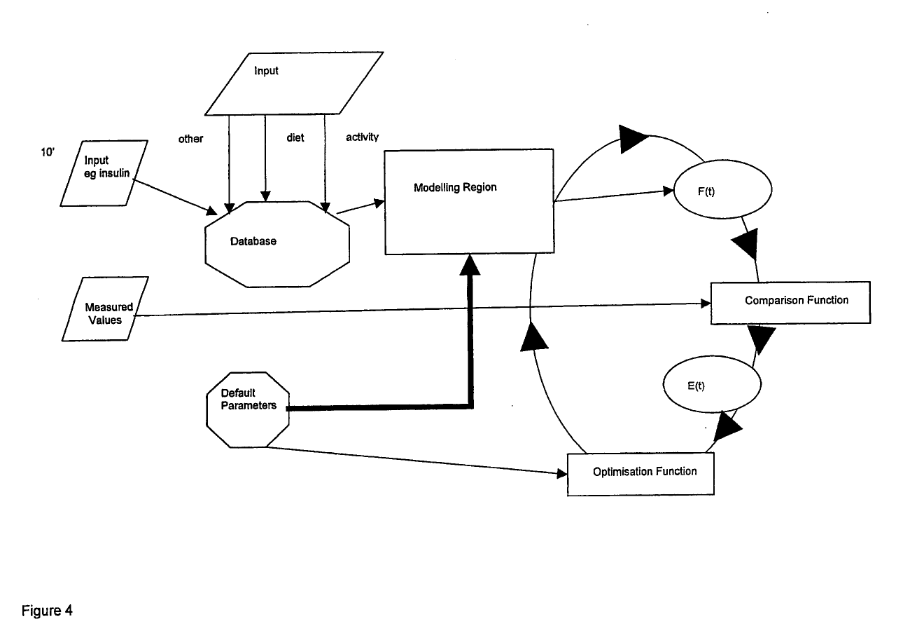

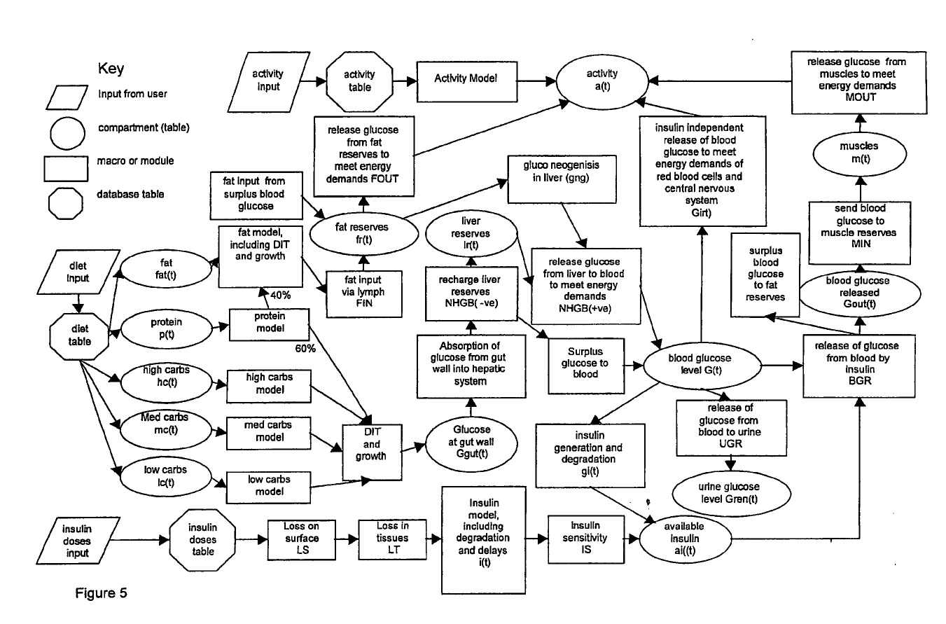

FIG. 4 shows a block diagram of a method which includes the input of the further set of data.

FIG. 5 shows a block diagram of a modelling system according to an embodiment of the invention.

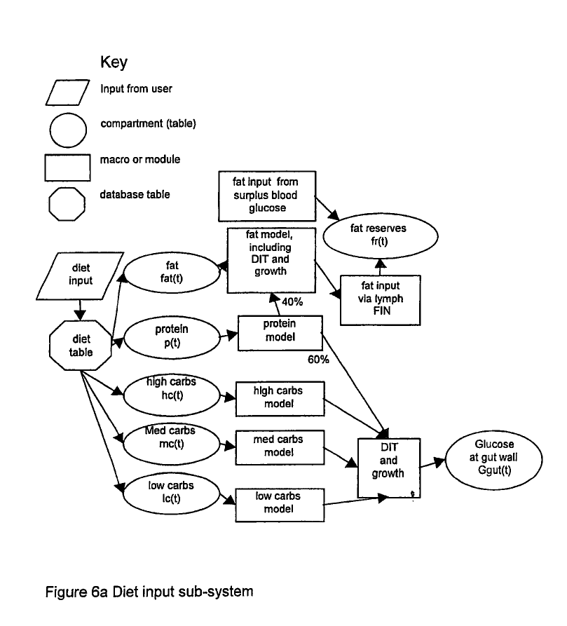

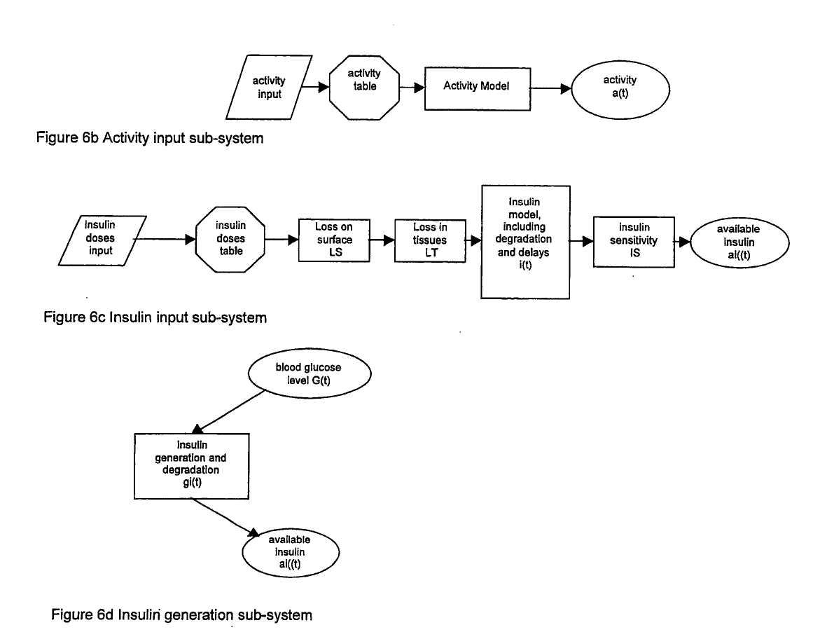

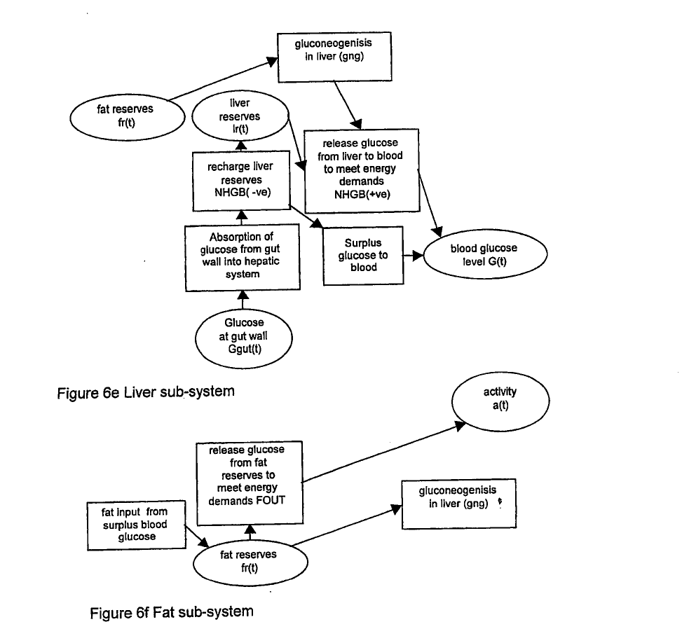

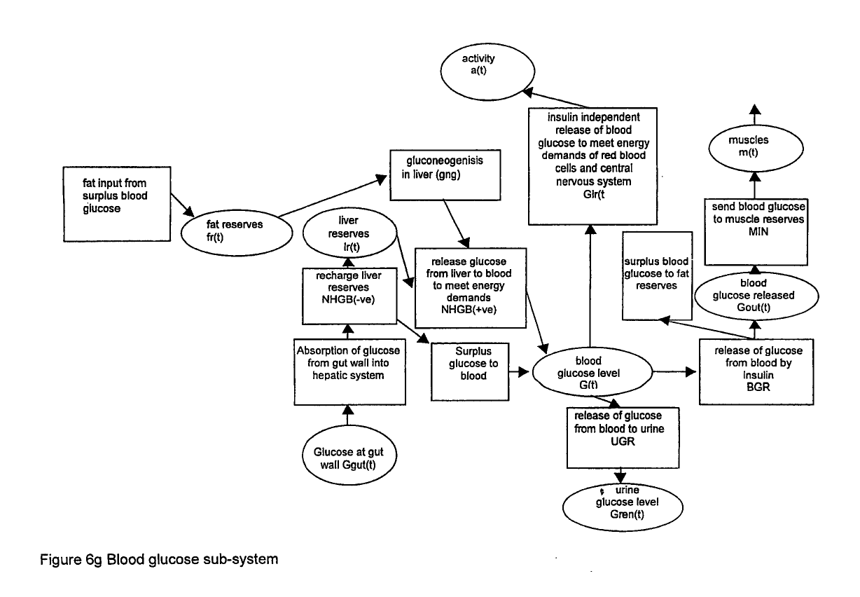

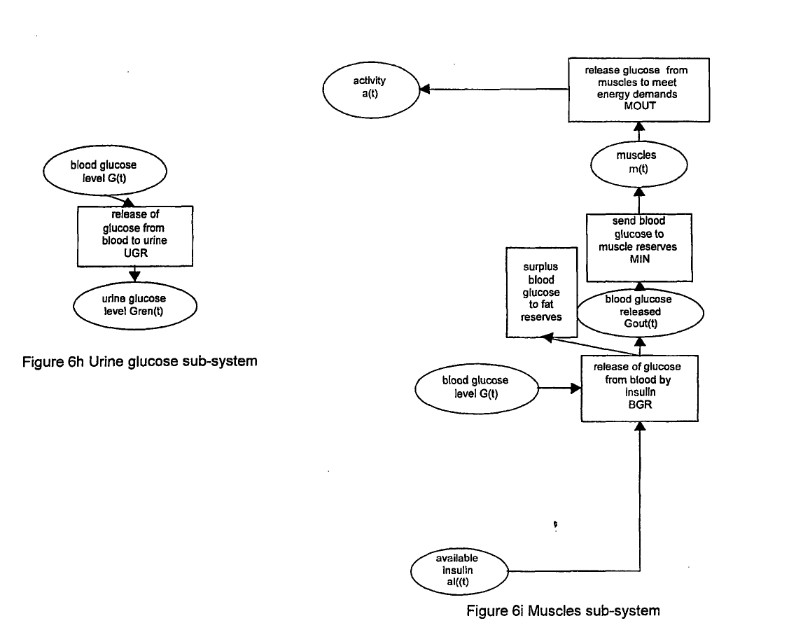

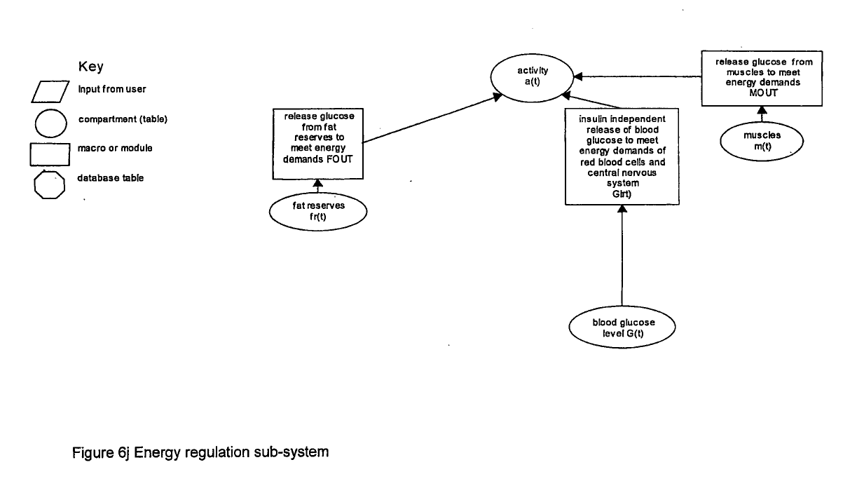

FIG. 6 illustrates how the modelling system shown in FIG. 5 can be divided into separate, interacting sub-systems as follows:

FIG. 6a shows the diet input sub-system

FIG. 6b shows the activity input sub-system

FIG. 6c shows the insulin input sub-system

FIG. 6d shows the insulin generation sub-system

FIG. 6e shows the liver sub-system

FIG. 6f shows the fat sub-system

FIG. 6g shows the blood glucose sub-system

FIG. 6h shows the urine glucose sub-system

FIG. 6i shows the muscles sub-system

FIG. 6j shows the energy regulation sub-system

Referring firstly to FIG. 1, the invention in its first aspect includes the input 10 of a first set of data 10a and a second set of data 10b into database 12. The first set of data 10a constitutes information on the diet of an individual. Typically, this comprises the input of the type of food consumed, the amount consumed, and the time consumed. The second set of data 10b constitutes information on the individual's activity. Typically, this comprises the type of activity undergone, and the period of time of the activity. Optionally, “other” data 10c is input into the database 12. This additional data may include date of birth, sex, height, weight, or any other such data to be used later in the modelling method.

There is also provided a third set of data 16, relating to hormone activity within the body. This data comprises parameters which correspond to the way an individual reacts to the presence of the hormone.

Modelling region 20 contains a series of mathematical models which access data and database 12 and date from the third set of data 16. The mathematical models employed use the parameters relating to the hormone activity, in combination with the diet data from database 12 and/or the activity data in database 12. Other data on the individual 10c may also be used by the mathematical models. The modelling region provides one or more output functions 30, 31, each of which represents the variation of a particular metabolic function with a respective time. For example, output function F(t) may provide data on the variation of glucose levels in the blood over time.

FIG. 2 shows a particular embodiment of the method of the invention including the modelling region in detail. FIG. 2 relates to the diet modelling portion of the method.

One embodiment of the invention requires the diet of the user to be described in the form of number of grams of protein, carbohydrate, sugars, fat in each meal or snack consumed. To facilitate this the invention uses tables of the composition of various food items, which can be added to by the user to reflect their diet. The user selects food items form this table, specifies the quantity of each item and so builds the menu of each meal and snack consumed. From this menu the required composition of each meal and snack consumed is determined for use by the model.

The system allows the user to save, recall, edit and save as new, menus for meals or snacks they consume on a regular basis. These features allow users to interact with the invention and input their diet data in a reasonable and time efficient manner. This aspect of the system achieves an acceptable data input time for users.

The diet input data 10a is stored in a diet table 12a within the database 12. A preliminary step provides a plurality of time courses 22(a) to (e) corresponding to the time variation of fat, protein, high carbohydrates, medium carbohydrates, low carbohydrates, input into the system. This step is carried out by simple calculations based on the nutrient content of the foods consumed according to diet input 10a.

For example, a user consumes a meal at time t=0, the meal comprising P grams of protein, H grams of fast acting carbohydrates (sugars), M grams of medium acting carbohydrates (carbohydrates—sugars), and F grams of fat (sum of saturated and unsaturated fat).

Time courses 22(a) to 22(e) represent the temporal variation of input of these nutrients. The model is able to estimate the approximate calorie input from the quantities of fat, protein, and carbohydrate into the metabolic system.

This particular method provides output functions corresponding to the time variation of fat reserves, Fr(t) (the lymphatic system), and the time variation of liver reserves, Lr(t) (the hepatic system). Thus the calorie input into both the lymphatic system and the hepatic system is modelled.

The different carbohydrate components are considered to act in discrete time intervals. The fast-acting carbohydrate component is considered to act 30-60 minutes after the meal consumption, and the calories input into the hepatic system in each ΔT time interval, d_{glu} is:
d_{glu}=4HΔT/30

The medium-acting carbohydrate component is considered to act 60-240 minutes after the meal consumption, and the calories input into the hepatic system in a ΔT time interval in this period is:
d_{glu}=4MΔT/60

The protein model 24b breaks up the protein component into glucose (60%) and fat (40%), and these sub-components can subsequently enter the hepatic and lymphatic routes during the 120-240 minute interval after consumption of the meal. Thus, the hepatic input is modelled as:
d_{glu}=0.6*4PΔT/120
and the input into the lymphatic system is:
d_{fat}=0.4*4PΔT/120.

The fat model 24a uses data in the fat time course and data from the protein model to model the calorie input into the lymphatic system 26a. The model estimates the time of the input from the fat component as being after 120 minutes from the meal consumption. However, an extra factor is included in the fat model to take into account the percentage fat content of the meal, and how it can affect the duration and amplitude of release into the lymphatic system. If greater than 30% of the total calories come from fat, then the amplitude of release is scaled down, and the duration of release is scaled down. That is:

If 9*F/C>0.3, where C=4*(P+H+M)+9*F, then the duration of release is estimated as 120 to X minutes after the meal consumption with X is calculated as:
X=9F120/(0.3*C)

The calorie input into the lymphatic system, d_{fat}, is modelled as:
d_{fat}=0.3CΔT/X

If the calories from fat comprise less than 30% of the total calories, then the release period is given as 120 minutes to 240 minutes after consumption, and:
d_{fat}=9FΔT/120

In this model high carbohydrates, medium carbohydrates, low carbohydrates and 60% of the protein are all modelled differently due to their differing action times within the body.

Module 27 accounts for diet-induced thermogenesis (DIT) and growth. DIT is the production of heat due to the food eaten and accounts for the synthesis of enzymes that digest the food and the energy utilised by absorption processes. This accounts for 8 to 10% of the metabolisable energy intake. DIT has been implemented in the model by reducing the glucose and fats arising at the gut wall by a particular factor. In addition, the model makes an estimate for the amount of dietary intake utilised for growth and repair.

DIT and growth have been accounted for as follows. The expressions d_{fat} and d_{glu} are modified by a factor according to the following equations to give the actual calories digested and available for absorption from the get, dggut (hepatic system), and dfgut (lymphatic system)
dggut=d_{glu}*(1−(DIT+GROWTH))
dfgut=d_{fat}*(1−(DIT+GROWTH))

Further modelling takes place, namely to model the way that glucose is absorbed from the gut wall into the hepatic system, and subsequent input into the liver reserves. In this way, an output function of the time variation of the liver reserves Lr(t)is calculated, as is the time variation of fat reserves Fr(t).

FIG. 2 illustrates the complexity of the modelling system. It can be seen that a number of mathematical models are used at various stages of the modelling process, in order to provide one or more time variable output functions. It is evident that further output functions could be displayed according to the application of the modelling method. For example, 28 provides data on glucose at the gut wall Ggut(t), and if required this information could be presented to the user of the system, e.g. as a print out or in graphical form.

FIG. 3 shows a block diagram of an alternative embodiment of the invention. This embodiment is improved in the sense that certain model parameters are evolved to fit the model to a particular user.

Parameters used within the invention can be divided into two categories. Firstly, there are those which are the same for all users which are based on chemical constants etc. Secondly, there are those which are different for each user, and are located in a user interface table within the database. The values of these parameters are originally given a default value within the third data set, but for improved results these parameters need to be fitted to each individual user.

As can be seen from FIG. 3, there is provided an additional input 17 for inputting or importing measured values into the system. These measured values may correspond to, for example, blood glucose levels taken at discrete time intervals. Output function 30 is calculated according to the general principles of FIG. 1. In this case, the output function gives the time variation of the blood glucose levels based on data input 10a, 10b and parameters held within the third data set.

A comparison module is provided in order to compare the results of the calculated function and the directly measured values from input 17. At the times at which the measured values are taken, the value for an error is calculated by subtracting the recorded value of blood glucose level from the modelled value, and expressing as a percentage of the blood glucose value. Thus, error function E(t) 42 is provided.

Incorporated into this embodiment is an optimisation step 50. The optimisation module accesses default parameters from the third data set and changes the values one by one. Output function F(T) is recalculated using the modified parameters and the comparison module 40 again compares the measured values with the modelled values, to provide the new error function E(T). The optimisation module then determines an increase or decrease in the error function E(T) and the process is repeated. Reiteration of this process enables the parameters used from the third data set, to evolve to the individual in question. By minimising the error function, it is possible to provide a more realistic model of hormone activity in an individual.

There will now be described by way of example a particular embodiment being adapted to model the blood glucose levels of a Type 1 diabetic.

FIG. 4 shows a block diagram of a modelling system, similar to that of FIG. 3, but with an additional input 10′. This input is for entering data relating to preparations taken by the individual that effect the hormone levels. For example, in the case of the diabetic modelling system input 10′ will include the entering of insulin doses taken by the individual. In alternative applications input 10′ may include information on drug intake, or the intake of other specific hormones.

Modelling region 20 contains a series of mathematical models designed for predicting the activity of the insulin in the body. A number of factors accounted for can be seen in FIG. 5, which shows the interaction of various models in a diabetic user. This system can be described as a series of interacting subsystems as shown in FIGS. 6a to 6j.

FIG. 6c shows that the insulin doses input is stored in an insulin doses table within the main database. Loss of insulin at the surface and in the body tissue is accounted for before the main insulin model is employed. More information about the insulin model will be provided below, but it is the intention to first outline the principles according to this aspect of the invention.

This embodiment uses a complex and extended model which models various insulin types, examples follow:
Type 1: Actrapid
Type 2: Protophane
Type 3: Monotard
Type 4: Ultratad
Type 5: Humalog
Type 10: Human Mixtard 10
Type 20: Human Mixtard 20
Type 30: Human Mixtard 30

There is a delay between the time of injection of the insulin and the time at which its action commences. This delay is dependent upon the type of insulin and the individual person with diabetes. In the model, the delay is incremented as a fixed, nominal value for a particular type of insulin, multiplied by a factor that is both insulin and user dependent. This allows the action time to reach the individual insulin times to be customised to each user.

There is a user dependent insulin sensitivity associated with each type of insulin. This allows the action of each insulin to be customised to each user.

There is a user dependent insulin elimination rate associated with each type of insulin. This allows the elimination of each insulin to be customised to each user.

All of the parameters are given initial, default values held within the third data set. The model is then run to give an initial start point, to provide an output function 30. As described above, the values calculated by the output function are directly compared to the measured values by the comparison function, to calculate an error function E(T). That is, the values of the modelled glucose levels are compared to the measured blood glucose levels to provide a blood glucose error function.

By varying the values of the parameters above, it is possible to reduce the value of the blood glucose error function. This can be done by standard optimisation techniques. For example for a cycle which modifies the parameter value, recalculates the modelled blood glucose function, compares the function to the measured values and recalculates the blood glucose error.

For the evolution process to operate with a reasonable possibility of success, it is recommended that the user provides a few days of nominal data. Nominal data is regarded as a period when the user is participating in the nominal routine of diet and exercise, and is not suffering from any ailments that will compound or complicate the model.

There is now described, an example of an insulin model which may be deployed in an example embodiment of the invention being applied to an insulin dependent diabetic. The insulin input sub-system is illustrated in FIG. 6c.

Plasma insulin for a Type 1 diabetic is defined as A(t), and is effected by a dose of D units which begins to have an effect at time t=0.

Rate of change of plasma insulin dA(t)/dt has two components, corresponding to an absorption process (first, positive term) and an elimination process (second, negative term), given by the equation:

$$\frac{ⅆ A ( t )}{ⅆ t} = \frac{s \cdot {t}^{s} \cdot {( {T}_{50} )}^{s} \cdot D}{t \cdot {( {( {T}_{50} )}^{s} + {t}^{s} )}^{2}} - {k}_{e} \cdot A ( t )$$

$$where$$

$${T}_{50} = a \cdot D + b$$

s, a and b (and hence T₅₀) are parameters that depend on the type of insulin being used. The insulin elimination rate, Kₑ, may depend on the type of insulin being used.

As explained above, there is a delay between the time of injection of the insulin and the time at which its action commences (defined as t=0 above). This delay is dependent on the type of insulin and the individual person with diabetes. The delay is implemented as a fixed, nominal value for a particular type of insulin multiplied by a factor that is both insulin and patient dependent. This allows the action times of each of the individual insulin types to be customised to each user. Insulin types currently modelled are listed in the table below:

| | Insulin | | | | |
|---|---|---|---|---|---|
| | type no | | | | |
| | 1 | 2 | 3 | 4 | 5 |
| Novo | Actrapid | Protophane | Monotard | Ultratard | |
| nordisk | | | | | |
| name | | | | | |
| Lilly | Humalin S | Humalin I | Humalin | | Humalog |
| Name | | | Lente | | |
| Generic | Regular | NPH | Lente | Ultralente | Lyspro |
| Name | | | | | |
| Other | Velosulin | Insulatard | | | |
| names | | | | | |
| S | 2 | 2 | 2.4 | 2.5 | 2 |
| a(hours | 0.05 | 0.18 | 0.15 | 0 | 0.05 |
| per unit) | | | | | |
| b(hours) | 1.7 | 4.9 | 6.2 | 13 | 1.7 |
| Kₑ (per | 5.4 | 5.4 | 5.4 | 5.4 | 5.4 |
| hour) | | | | | |
| Nominal | 45 | 105 | 105 | 240 | 0 |
| delay | | | | | |
| (minutes) | | | | | |
| Duration | 16 | 24 | 24 | 36 | 16 |
| (hours) | | | | | |

No data on Humalog was available at the time of writing, these values are based on actrapid with zero time delay, as a first approximation.

The various forms of mixtard, such as human mixtard 30, are modelled as combinations of doses of type 1 and type 2 insulin from the above table.

The generation of insulin in the pancreas is also modelled, according to the following equation:

$$\frac{ⅆ i ( t )}{ⅆ t} = γ \cdot {[ g ( t ) - h ]}^{+} - {k}_{e} \cdot i ( t )$$

where i(t) is the generated insulin concentration, g(t) is the blood glucose concentration—in grams per litre, and h is a threshold value of blood glucose. The insulin generation sub-system is shown in FIG. 6d.

The value of γ used is 3.37*35E—3/0.18=0.655278 hours⁻¹

An initial, basal, level of insulin concentration, i(0), is also required. In the model a value of 15 mU/litre is assumed.

The amount of insulin generated is determined by a the user dependent insulin production parameter. This is expressed as a percentage (0%=no insulin production, totally diabetic, 100%=non-diabetic). The value of the insulin production parameter is determined from the users date of birth, sex, height and weight, which gives an expected insulin requirement, and their nominal daily insulin dose. Any difference is due to insulin production, which can then be quantified.

With these values in place the insulin values generated for non-diabetics resemble those described by other authors.

The output from the input and generated insulin models are combined to form a model of the insulin concentration in the users blood. This combination takes into account the effect of the user dependent insulin sensitivity parameter on input insulin, and the user dependent insulin production parameter on the insulin produced.

The activity model utilises a table of adult and child activities in the activity input system shown in FIG. 6b. These contain the Physical Activity Ratio (Base metabolic rate multiplying factor) for each activity. Users specify activities by the name of the activity, its start time and duration. From this and the users birth date, sex, height and weight the calories consumed by that user in that duration of activity can be determined.

The user describes their activity in a day as follows, firstly they define when they woke up and when they went to bed. The model then uses their sleeping metabolic rate do determine how many calories are being used per minute while the user is asleep and awake, but not engaged in strenuous activity. During the day users report any activities that accelerate their base metabolic rate, based on the physical activity ratios in the activity tables described earlier. The additional calories used per minute during each activity is then determined and added to the energy demand by the user for that day.

The liver sub-system, shown in FIG. 6e, accepts inputs of glucose from the gut wall to recharge the liver reserves, and from the fat reserves during gluconeogenesis, when the liver reserves are low to supplement them. The liver outputs glucose to the blood either from liver reserves or fat gluconeogenesis. The liver action, at any point in time, is determined by blood insulin level, blood glucose level, food input from the gut and the status of the liver reserves. The liver actions the flowing processes: input to reserves, output from reserves, enable gluconeogenesis, and disable gluconeogenesis.

The fat sub-system, shown in FIG. 6f, accepts fat input from the diet, and also can store surplus blood glucose as fat under certain conditions. Body fat can be called on to meet the energy demands of activity directly, and to provide fuel via gluconeogenesis in the liver if the liver reserves become depleted.

The blood glucose sub-system, shown in FIG. 6g, accepts glucose from the liver system, either from food surplus to the liver's needs, the liver reserves of gluconeogenesis in the liver. Once in the blood glucose can leave independently of the blood insulin concentration to fuel fundamental body functions, such as the brain and central nervous system. It can leave in a manner dependent on blood insulin concentration to the muscles and for any surplus to be saved as body fat. If the blood glucose level exceeds the renal threshold (9 mmol/l) the kidneys commence removal of some blood glucose via the urine.

The urine glucose sub-system, shown in FIG. 6h, allows the body to attempt to bring down high levels of blood glucose. If the blood glucose level exceeds the renal threshold (9 mmol/l) the kidneys commence removal of some blood glucose via the urine.

The muscles sub-system, shown in FIG. 6i, allows glucose released from the blood by the action of insulin in the blood to replenish muscle glycogen stores that have been depleted by activity.

The energy regulation sub-system, shown in FIG. 6j, allows the energy demands of the body, as determined by the activity input sub-system, to be met. The body has several possible sources of fuel, fat, muscle glycogen stores, and blood glucose released independently of blood insulin concentrations. Which fuel source is used, and how much is related to, for instance, the demand, the state of some of the fuel sources (particularly the blood glucose and liver glycogen store).

The above subsystems are modelled by utilising various equations and mathematical models. Indeed, each transition from one data table to another table or function is implemented by a mathematical model or equation. The equations used may be any suitable for modelling the metabolic system in question.

It will be apparent to one skilled in the art that various modifications and adaptations to the described system are possible within the scope of the invention. The invention is not limited to particular equations used in the modelling method. As research continues, it is envisaged that improved mathematical representations may be incorporated into the invention.

The present invention allows a person with diabetes, or a person that cares for diabetes sufferers to experience an improvement in diabetic control by gaining a better understanding of the condition and how various parameters are affected. This results in an improvement in the life style for the person with diabetes and those caring for them.,

The invention allows the exploration of so-called “what if” scenarios, eg “what happens if the person with diabetes misses a snack before exercise?”, or “could better control have been achieved if the person with diabetes had eaten their snack sooner/later, undergone a different type of activity, or reduced/increased their insulin dose”.

By inputting data corresponding to a planned snack or activity, the effect on the blood glucose levels (or other metabolic functions) can be predicted. The user can quickly see the effects of adding or removing a snack without entering a large amount of data. Further, the method may selectively display the data, such that the user sees the predicted results only when a the planned snack or activity would cause a significant change to the blood glucose levels.

It should be noted that the same benefits apply to non-diabetic individuals who wish to model particular aspects of the metabolism.

Further modifications and improvements may be incorporated without departing from the scope of the invention herein intended.

1. A method of calculating the time variation of a metabolic parameter of an individual, the method comprising the steps of:
(a) Inputting data into a database, the data including diet data relating to the diet of the individual and activity data relating to the activity of the individual, and personal data of the individual constituting one or more of date of birth, sex, height, or weight;
(b) Providing hormone interaction parameters relating to activity of one or more hormones;
(c) Calculating using a plurality of mathematical models, the time variation of a metabolic parameter, wherein the mathematical models utilize the hormone interaction parameters in conjunction with the diet data and/or the activity data, and model the energy stores, being the blood glucose, liver reserves, fat reserves, and muscle glycogen reserves of the body of the individual in calculating the time variation of a metabolic parameter.

2. The method as claimed in claim 1, wherein the step of calculating the time variation of the metabolic parameter includes determining which of the energy stores are used to meet energy demands from the state of the energy stores.

3. The method as claimed in claim 1, wherein the step of calculating the time variation of the metabolic parameter models the liver action of the individual, as determined by blood insulin level, blood glucose level, food input from the gut and status of the liver reserves.

4. The method as claimed in claim 1, wherein the hormone interaction parameters comprises a set of default parameters relating to the interaction of the one or more hormones with the individual.

5. The method as claimed in claim 4, wherein the hormone interaction parameters comprise one or more of the following user-dependent parameters: an insulin activity delay parameter, an insulin sensitivity parameter, an insulin elimination rate parameter, an insulin production parameter.

6. The method as claimed in claim 1 comprising the additional step of inputting or importing measurement data relating to the measurement of a variable in a metabolic system.

7. The method as claimed in claim 6, comprising the step of comparing the measurement data with calculated values of the metabolic parameter.

8. A The method as claimed in claim 7, wherein the step of comparing comprises the sub-step of calculating of an error function said error function being defined as the difference in the measurement data values and the calculated metabolic parameter values over time.

9. The method as claimed in claim 8, comprising the additional steps of modifying at least one of the default parameters included in the hormone interaction parameters, recalculating the time variation of the metabolic parameter using the modified parameter, and recalculating the error function.

10. The method as claimed in claim 9, wherein the additional steps of modifying at least one of the default parameters included in the hormone interaction parameters, recalculating the time variation of the metabolic parameter using the modified parameter and recalculating the error function are reiterated in order to minimize the error.

11. The method as claimed in claim 1, wherein the data is the blood glucose level.

12. The method as claimed in claim 1, wherein the hormone is insulin.

13. The method as claimed in claim 1 comprising the step of entering into the database data relating to insulin doses taken by the individual.

14. The method as claimed in claim 1 comprising the additional steps of selecting food items from a table of food items specifying a quantity of each food item, and determining the nutritional composition of food consumed.

15. The method as claimed in claim 14 comprising the additional step of calculating a plurality of time courses corresponding to the time variation of fat, protein, and carbohydrates input into the metabolic system.

16. The method as claimed in claim 1, wherein the input of activity data includes the sub-steps of selecting an activity from a table of activities, and specifying a start time and duration of the activity.

17. The method as claimed in claim 16 comprising the step of determining the calories consumed by the individual user during the activity from the activity data a basal metabolic rate determined from the birth date, sex, height, and weight of the individual and a basal metabolic rate multiplying factor associated with the activity.

18. The method as claimed in claim 1, wherein the metabolic parameter is selected from the group comprising: insulin levels in the blood, input of glucose from diet, input of fat, liver glucose reserves, fat reserves, muscle reserves, glucose output due to activity, rate of change of urine glucose, glucose used by the central nervous system, modelled blood glucose, and blood glucose error.

19. The method as claimed in claim 1, comprising the step of displaying calculated values to a user.

20. A method for calculating the effect of a change in diet, activity or insulin dose taken on the time variation of a metabolic parameter of an individual, the method comprising the steps of:
a) Calculating the time variation of a metabolic parameter;
b) Inputting data corresponding to a planned or retrospective change in diet, activity or insulin dose into a database;
c) Calculating, using a plurality of mathematical models, the time variation of a metabolic parameter, wherein the mathematical models utilize the hormone interaction parameters in conjunction with the data corresponding to a planned or retrospective change in diet, activity or insulin dose taken and model the blood glucose levels, liver reserves, fat reserves, and muscle glycogen reserves of the body of the individual in calculating the time variation of a metabolic parameter for the planned or retrospective change in diet or activity, or insulin dose taken.

21. The method as claimed in claim 20 comprising the additional step of displaying values of the metabolic parameter to a user.

22. The method as claimed in claim 20 comprising the additional step of comparing the time variation of the metabolic parameter with the time variation of a metabolic parameter for a planned or retrospective change in diet, activity, or insulin dose, in order to provide information on the difference effected by the planned or retrospective change in diet, activity or insulin dose taken.

23. The method as claimed in claim 20, wherein the method is executed by a computer program.

24. A computer program adapted to execute the method claimed in claim 20.
